(19) United States
(12) Patent Application Publication
(10) Pub. No.: US 2003/0069998 A1
(43) Pub. Date: Apr. 10, 2003

(54) Motion services protocol accessible through uniform resource locator (URL)

(76) Inventors: David W. Brown, Bingen, WA (US); Skylar Stein, Bingen, WA (US)

Correspondence Address: SCHACHT LAW OFFICE, INC., SUITE 202, 2801 MERIDIAN STREET, BELLINGHAM, WA, 98225-2412, US

(21) Appl. No.: 10/234,364

(22) Filed: Sep. 3, 2002

Related U.S. Application Data
(60) Provisional application No. 60/316,755, filed on Aug. 31, 2001.

(51) Int. Cl. G06F 15/00; G06F 9/00

(52) U.S. Cl. 709/310; 715/500

(57) ABSTRACT

A motion system comprising a motion enabled device, an application, a motion URL protocol handler, and a motion services module. The motion enabled device performs motion operations based on motion commands. The application transmits a motion URL request, where the motion URL request corresponds to a desired motion operation. The motion URL protocol handler receives the motion URL request and converts the motion URL request into a motion API command. The motion services module generates at least one motion command corresponding to the desired motion operation based on the motion API command generated by the motion URL protocol handler. The motion services module runs the at least one motion command on the motion enabled device such that the motion enable device performs the desired operation.

### RELATED APPLICATIONS

The present application claims priority of U.S. Provisional Patent Application Serial No. 60/316,755 filed Aug. 31, 2001.

### FIELD OF THE INVENTION

The present invention relates to motion systems and, more particularly, to systems and methods for causing motion based on remotely generated URL requests.

### BACKGROUND OF THE INVENTION

The present invention is of particular use in motion systems that perform desired movements based on motion commands.

### SUMMARY OF THE INVENTION

The present invention is a motion system comprising a motion-enabled device, an application, a motion URL protocol handler, and a motion services module. The motion-enabled device performs motion operations based on motion commands. The application transmits a motion URL request, where the motion URL request corresponds to a desired motion operation. The motion URL protocol handler receives the motion URL request and converts the motion URL request into a motion API command. The motion services module generates at least one motion command corresponding to the desired motion operation based on the motion API command generated by the motion URL protocol handler. The motion services module runs the at least one motion command on the motion enabled device such that the motion enable device performs the desired operation.

### BRIEF DESCRIPTION THE DRAWING

FIG. 1 is a block diagram depicting a motion control system of the present invention;

FIG. 2 is a scenario map depicting how the motion control system of FIG. 1 handles a motion URL request;

FIG. 3 is a scenario map depicting a registration process performed by the motion control system of FIG. 1; and

FIG. 4 is a scenario map depicting how the motion control system of FIG. 1 may be configured to generate a debug file.

### DETAILED DESCRIPTION OF THE INVENTION

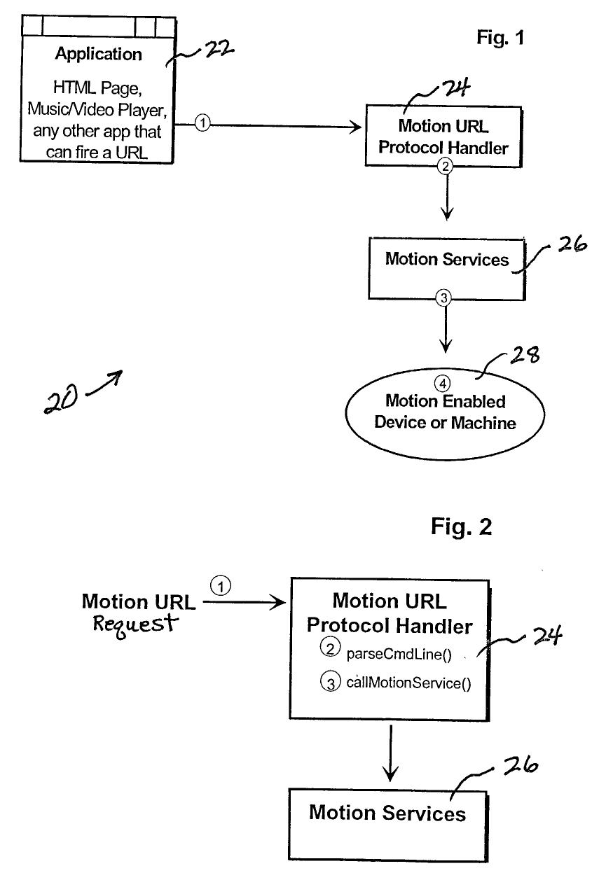

Referring initially to FIG. 1 of the drawing, depicted at 20 therein is motion control system constructed in accordance with, and embodying, the principles of the present invention. The motion control system 20 comprises an application program 22, a motion Uniform Resource Locator (URL) protocol handler object 24, a motion services component 26, and a motion enabled machine or device 28.

The application program 22 is any application that can generate a URL command. For example, most internet applications, as well as selected multimedia applications and streaming multimedia formats, have the ability to call URL commands. Typically URL commands can be used to display web pages, send email, or perform other specialty functionality. Examples of the application program 22 are web browsers (along with any program which can host HTML-based content), Microsoft® Media Player when playing ASF (Advanced Streaming Format) media that contains time-indexed URL events (see www.microsoft.com), and Macromedia® Flash and Shockwave media that fire URL commands (see www.macromedia.com).

The motion enable machine or device 28 is any device capable of converting motion commands into physical movement. As examples, toys and other consumer devices have the ability to convert motion commands into movement. Other examples of a motion enabled machine or device 28 would be robots and industrial machines configured to perform a manufacturing process. An industrial machine of this type will typically comprise a computer numerical control (CNC) or general machine controller (GMC) coupled to a motion device such as a multi-axis machine.

The motion services component 26 is a software middleware component capable of generating low-level motion commands for controlling the motion enabled device or machine 28. The motion services component 26 may be hardware independent, in which case the component 26 will typically translate high-level application commands into low-level motion commands appropriate for the motion enabled device or machine 28.

An example of such a motion services component is described in U.S. Pat. Nos. 5,691,897 and 5,867,385 to Brown et al.; the disclosure of the Brown et al. patents is incorporated herein by reference. The technologies disclosed in the Brown et al. patents are embodied in a line of commercial product released by Roy-G-Biv Corporation under the tradename “XMC”. One such product is the XMC motion services component of the XMC for Visual Studio product sold by ROY-G-BIV Corporation. The XMC product-line is described in further detail at www.rovqbiv.com.

Alternatively, the motion services component 26 may be hardware dependent, in which case the motion services component 26 simply passes through machine specific commands without translation. In this case, the primary function of the component 26 is to handle “housekeeping” functions such as timing, network protocol conversion, and data format conversion.

As a yet another alternative, the motion services component may be hardware independent but allow machine specific commands to be passed through without translation. The motion component described in the Brown '897 patent is hardware independent but employs ‘pass-through’ functionality to operate in a hardware dependent mode if necessary.

The motion URL protocol handler 24 allows for the control of motion devices 28 via the URL command calling functionality conventionally implemented by internet applications, multimedia applications, and streaming multimedia formats. The term “URL request” will be used herein to refer to commands, instructions, and/or data related to a particular URL device.

The present application allows the use of a new type of URL request that will be referred to herein as a “motion URL request.” The motion URL protocol handler 24 converts motion URL requests into motion commands, instructions, and/or data that can be processed by the motion enabled device or machine 28 to cause a desired movement or sequence of movements.

A method of the present invention will now be described in further detail with reference to FIG. 1. When the application 22 generates a motion URL request, the motion URL request is sent to the motion URL protocol handler component 24. The motion URL protocol handler component 24 processes the motion directives in the motion URL request to obtain API commands recognized by the motion services component 28. The API commands may be either machine specific code or high-level commands that must be translated into machine specific code by the motion services component 26. In either case, the motion services component 26 sends motion commands to the motion enabled device or machine 28 that cause the machine or device 28 to move in accordance with the motion directives in the motion URL requests sent by the application 22.

In particular, when using a motion URL request to cause physical motion, the following steps occur.

First the application 22 generates or “fires” a Motion URL request. The motion URL request can be fired from an HTML page (i.e. from a click on a hyperlink), time-indexed URL events from audio/video played from a Media Player, or any other application that is able to fire URL commands.

The operating system associated with the application 22 dispatches the motion URL request to the registered motion URL protocol handler 24. This object interprets the motion URL request to determine the requested motion command(s), instructions, and/or data.

The motion URL protocol handler 24 uses the motion services component 26 to perform the motion operations and/or run programs on the target device 28. When directed, the motion enabled machine or device 28 carries out the physical motions requested.

The details of the motion URL protocol handler 24 used to interpret or translate the motion URL requests into the motion API commands will now be described in further detail.

Before motion URL requests may be fired from a client application 22, the motion URL protocol handler 24 must be registered on the operating system on which the application 22 is running. To register the protocol handler 24 on a Microsoft Windows operating system, the following keys are added to the Windows Registry. Note that the sample values below assume the motion URL protocol handler object 24 is located at C:\MotionHandler.exe, but the motion URL protocol handler 24 may reside elsewhere on the system.

[HKEY_CLASSES_ROOT]

[motion]

(Default) = “URL:Motion Protocol”
URL Protocol = ““
[DefaultIcon]

(Default) = “C:\MotionHandler.exe,100”

[shell]

[open]

[command]

(Default) = “C:\MotionHandler.exe” “%1”

More information for registration of a motion URL protocol handler with a Windows operating system can be found by searching for “Asynchronous Pluggable Protocols” at http://msdn.microsoft.com/.

As generally described above, the motion URL protocol handler 24 processes the motion URL request once the URL request is fired from a client application 22. Two examples of common motion URL requests that may be processed by the motion URL protocol handler 24 will be described below.

The first common motion URL request is a “run stored motion program” request. To run a stored motion program, a client application 22 might issue a motion URL request in the following format:

motion: runscript?script_runprogram,sample

When run (i.e. by clicking on a hyper-link HTML button associated with the above text), the motion URL protocol handler 24 would run the stored program named “sample” stored at the motion services component 26. To process a “run stored motion program” motion URL request, the program associated with that request must be present at the motion services component 26. The motion services component 26 manages such programs and will run the appropriate program if already downloaded or, if not already downloaded, download the appropriate program from a separate motion content server, if available.

A second common motion URL request is a “run online motion command” motion URL request. To perform “online” control of a motion device 28, a client application 22 might issue a motion URL request in the following format:

motion:runscript?script_motor_moveabsolute, 10,15,50

When the motion URL protocol handler 24 receives a “run online motion command” motion URL request as set forth above, the handier 24 would generate a motion API command corresponding to a “Move Absolute” command with the parameters 10, 15, and 50. In a hardware independent mode, the motion services component 26 would translate this API command into a “Move Absolute” command appropriate for the motion enable device or machine 28 to cause the machine or device 28 to move in the first axis 10 units, the second axis 15 units, and the third axis 50 units.

The motion URL protocol handler 24 and motion services component 26 support additional commands to perform any required action on the motion device 28, including stored motion directives, online motion commands, and motion device configuration. The XMC motion services component is capable of performing virtually any motion operation using its underlying control system.

Common usage tasks performed by the Motion URL Protocol Handler will now be described with reference to the scenario maps of FIGS. 2, 3, and 4.

Referring first to FIG. 2, this scenario map details the specifics of handling a motion URL request. In particular, in a first step a motion URL request is dispatched to the motion URL protocol handler 24 by the operating system associated with the application 22.

In a second step, the motion URL request arrives via a command line argument to the motion URL protocol handler 24. The handler 24 must determine the command type of the motion URL request. One example of a possible command line argument to the protocol handler 24 is as follows:

motion:runscript?Script_RunProgram,str:drill

The command line argument above contains the command type “runscript”, which requests that an identified motion services script be executed. In the example above, the script “Script_RunProgram” is requested. Any script supported by the motion service component 26 may be specified.

Following the script name is a comma-delineated list of script parameters. In the preferred embodiment of the present invention, string parameters are preceded by a “str:” token, and script parameters that are not preceded by this token will be converted to a ‘C’ language type of double.

In a third step, the specified script is then called via the motion services component 26. In the example set forth in the second step above, the script “Script_RunProgram” will be called with one parameter, the string “drill”.

Another example of a motion URL request is as follows:

motion: runscript?Script_Motor_SetVelocity,35,50,10.5

This motion URL request would cause the script Script_Motor_SetVelocity to be run with three parameters of type double, 35.0 for the first axis, 50.0 for the second axis, and 10.5 for the third axis. In the context of the XMC for Visual Studio product discussed above, more information on calling scripts using the XMC motion component can be found in the ‘XMC Service Reference’ document published ROY-G-BIV Corporation.

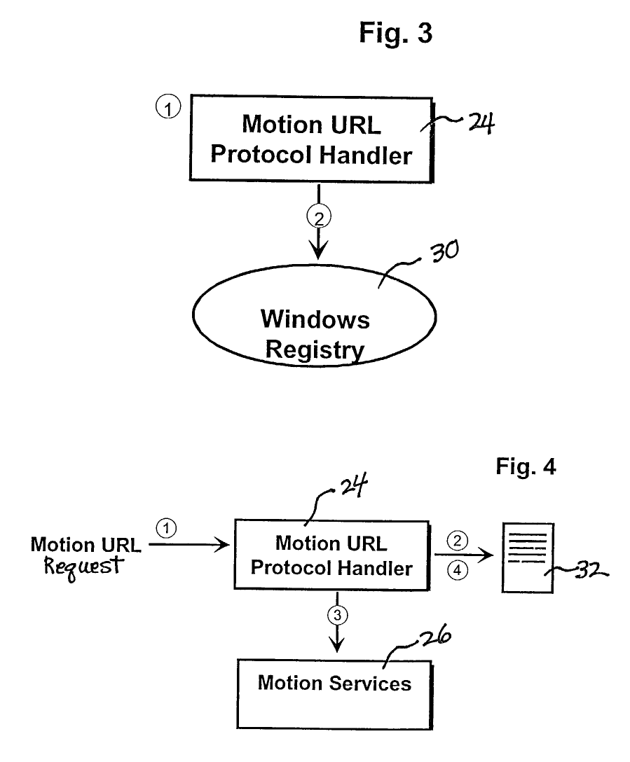

As discussed generally above, before motion URL requests can be dispatched, the motion URL protocol handler 24 must be registered on the system on which the application 22 operates. This registration process will now be described in further detail with reference to FIG. 3

The first step in the registration process is to execute a motion handler associated with the application 22 with the command line argument “/RegServer” (i.e. “c:\motionhandler.exe /RegServer”).

As a second step, upon receiving the appropriate command line, the motion handler parses the command line, locates “/RegServer”, and if present, registers the required protocol information in the Windows Registry 30 as generally discussed above. To unregister the motion protocol handler, the command line argument “/UnRegServer” is used in the same manner, except that, when an ‘UnRegServer’ command line argument is received, the server removes itself from the Windows Registry 30.

It can be helpful to debug the protocol data processed by the motion URL protocol handler 24. The generation of a debug output file 32 will now be described with reference to FIG. 4.

To configure a debug output file where verbose processing information will be logged, the motion handler EXE can be run with the command line argument “/Debug”. In the context of a Windows operating system, the following command line can be used to create a debug output file:

C:\motionhandler.exe /Debug “C:\Temp\output.txt”

This command line defines the debug output file as C:\Temp\output.txt. Once the debug output file 32 has been defined, the motion URL protocol handler 24 will perform the following steps as shown in FIG. 4.

First, a motion URL request is dispatched to the handler 24. As the handler 24 parses the motion URL request, each token (and error result if any) will be logged to the selected output file 32. Second, the handler calls the motion services component 26 as usual. Third, the exact parameters sent to (as well as the return error results received from) the motion services component 26 will be logged to the output file 32.

To disable debug output, the motion handler Exe is run with the “/Debug” command line argument and with an empty filename parameter as follows:

C:\motionhandler.exe /Debug

or

C:\motionhandler.exe /Debug “”

Either of these command lines will clear any previously defined output file, and the protocol handler will no longer log parsing and error results.

We claim:

1. A motion system comprising:
a motion enabled device that performs motion operations based on motion commands;
an application that transmits a motion URL request, where the motion URL request corresponds to a desired motion operation;
a motion URL protocol handler, where the motion URL protocol handler receives the motion URL request and converts the motion URL request into a motion API command;
a motion services module for generating at least one motion command corresponding to the desired motion operation based on the motion API command generated by the motion URL protocol handler; whereby
the motion services module runs the at least one motion command on the motion enabled device such that the motion enable device performs the desired operation.
